(19) United States
(12) Patent Application Publication
(10) Pub. No.: US 2025/0322509 A1
(43) Pub. Date: Oct. 16, 2025

(54) SYSTEMS AND METHODS FOR PREDICTING GERMINATION POTENTIAL OF SEEDS

(71) Applicant: RiceTec, Inc., Alvin, TX (US)

(72) Inventors: Hanoi Medina, Alvin, TX (US); Sailaja Koti, Alvin, TX (US); Jackson Nielsen, Alvin, TX (US); Lupitha Ramblas, Alvin, TX (US)

(21) Appl. No.: 18/637,156

(22) Filed: Apr. 16, 2024

(51) Int. Cl. G06T 7/00; G06T 7/11

(52) U.S. Cl. CPC G06T 7/0012; G06T 7/11; G06T 2207/10116; G06T 2207/20021

(57) ABSTRACT

Systems/methods for predicting the germination potential of seeds are disclosed. The methods include, by a processor: receiving an image comprising a plurality of seeds, and segmenting the image to identify instance masks associated with the plurality of seeds. For each of the plurality of instance masks, the methods include determining one or more of a plurality of characteristic labels, and determining based on the one or more of the plurality of characteristic labels, a germination potential of a seed associated with that instance mask.

### BACKGROUND

### Statement of the Technical Field

The present disclosure relates generally to computing systems. More particularly, the present disclosure relates to implementing systems and methods for determining germination potential of seeds, more particularly for determining germination potential rice seeds.

### Description of the Related Art

In agriculture, farmers have always needed high-quality seeds. High-quality seeds are characterized by a high germination ability, a high driving force and a homogeneous emergence behavior, among other things. In plant breeding, the use of high-quality seeds reduces costs of field experiments and increases the probability to identify a better crop variety. To be able to supply high-quality seeds, seed producers must classify and sort their seeds in order to be able to differentiate and separate high-quality seeds from lower quality seeds.

As such, accurate and efficient methods for evaluating germination are required. However, most tests for directly assessing seed germination are invasive and very time consuming. In fact, separation of seeds according to desired seed properties has traditionally been performed manually, which is an error-prone and time-consuming task. Moreover, manual sorting and classification generally depends upon easily determined physical differences in phenotype, for example, size differences and/or weight differences between seed grains containing an embryo and seed grains containing no embryo; and do not take into account invisible features of the seeds.

The present disclosure describes devices and methods directed towards solving some of the issues discussed above.

### SUMMARY

The present disclosure concerns implementing systems and methods for predicting the germination potential of seeds are disclosed. The system may include a processor, and a non-transitory computer-readable storage medium comprising programming instructions that are configured to cause the processor to implement the methods of this disclosure. The methods may include receiving an image comprising a plurality of seeds, and segmenting the image to identify instance masks associated with the plurality of seeds. For each of the plurality of instance masks, the methods include determining one or more of a plurality of characteristic labels, and determining based on the one or more of the plurality of characteristic labels, a germination potential of a seed associated with that instance mask. Optionally, the image may be an x-ray image.

In some implementations, segmenting the image to identify instance masks associated with the plurality of seeds may include slicing the image into a plurality of slices, and segmenting each of the plurality of slices using a Segment Anything Model (SAM). Optionally, slicing the image may include determining a first mask of the image using SAM, determining a second mask of the image using Scikit-image, identifying row and column indices associated with each of the plurality of seeds in the image based on the first mask and the second mask, and slicing the image using the row and column indices. Additionally and/or alternatively, the methods may include identifying and discarding instance masks that have one or more attribute values that do not correspond to seed masks and/or duplicate seed instance masks. Examples of such attribute values can include, without limitation, area, perimeter, length of main axis, length of secondary axis, inertia tensor, a ratio between the length of the main axis and length of the secondary axis, and a ratio between a diagonal and an off-diagonal element of the inertia tensor.

In various implementations, the plurality of characteristic labels may include, without limitation, broken, dehulled, diseased, empty, good, immature, open, and/or sprouted.

In various implementations, determining the germination potential of the seed associated with that instance mask based on the one or more of the plurality of characteristic labels may include determining the germination potential using a logical regression model. The logical regression model may include:

$$P ( G ) = \frac{exp ( {a}_{0} + {a}_{1} \times {D}_{1} + … {a}_{i} \times {D}_{i} + … {a}_{N} \times {D}_{N} )}{1 + exp ( {a}_{0} + {a}_{1} \times {D}_{1} + … {a}_{i} \times {D}_{i} + … {a}_{N} \times {D}_{N} )} \\ with \\ {a}_{i} ( i = 0 , 1 , 2 … 8 )$$

being coefficients of the model, and Di being a characteristic label.

In various implementations, determining one or more of the plurality of characteristic labels may include using a deep learning algorithm.

Optionally, the methods may also include generating an output that includes a graphical display indicative of, for the image: a number of seeds associated with each of the plurality of characteristic labels and an average germination potential.

### BRIEF DESCRIPTION OF THE DRAWINGS

The present solution will be described with reference to the following drawing figures, in which like numerals represent like items throughout the figures.

FIG. 1 is an illustration of an illustrative system.

FIG. 2 provides a flow diagram of an illustrative method for predicting the germination potential of seeds.

FIG. 3A is an illustration of an example x-ray image of a plurality of seeds.

FIG. 3B is an example illustration of slicing of an image.

FIG. 4 is an illustration of an image file including seed mask images.

FIG. 5 illustrates images of example seed characteristics.

FIG. 6A illustrates an example user interface showing the results of a seed germination prediction process on a seed sample.

FIG. 6B illustrates an example user interface showing the results of a seed germination prediction process on a seed sample.

FIG. 7 is an illustrative hierarchical probability tree.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

A “machine learning model” or a “model” refers to a set of algorithmic routines and parameters that can predict an output(s) of a real-world process (e.g., prediction of seed germination, a diagnosis or treatment of a patient, a suitable recommendation based on a user search query, etc.) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems utilize various types of statistical analyses, machine learning systems are distinguished from statistical analyses by virtue of the ability to learn without explicit programming and being rooted in computer technology. Each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data. A typical machine learning pipeline may include building a machine learning model from a sample dataset (referred to as a “training set”), evaluating the model against one or more additional sample datasets (referred to as a “validation set” and/or a “test set”) to decide whether to keep the model and to benchmark how good the model is, and using the model in “production” to make predictions or decisions against live input data captured by an application service.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The term “seed” refers to a seed of a plant which is a complete self-contained reproductive unit generally consisting of a zygotic embryo resulting from sexual fertilization or through asexual seed reproduction (apomixis), storage reserves of nutrients in structures referred to as cotyledons, endosperm or megagametophytes, and a protective seed coat encompassing the storage reserves and embryo. The seeds which are categorized according to the present invention may be derived from any plant.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

Rice is the world's most important staple, as more than 3.5 billion people it as food. Therefore, methods leading to improvements on production and quality of rice seeds have an immediate impact in the society. Among the quality indicators of rice seeds, germination is particularly important, as it considerably drives demand and sales of the product. Accurate and efficient methods for evaluating germination are required in the decision-making process of farmers, seed producers and researchers as it provides an estimation of the physiological potential of seed lots. However, as discussed above, current methods for assessing seed germination potential are invasive, labor intensive, and time consuming.

Specifically, one of the more labor intensive and subjective steps in the embryogenesis procedure is the selection of individual seeds suitable for germination. The seeds may be present in a number of stages of maturity and development. Those that are most likely to successfully germinate into normal plants are preferentially selected using a number of visually evaluated screening criteria. Morphological features such as axial symmetry, cotyledon development, surface texture, color, and others are examined and applied as a binary pass/fail test for selecting seeds having germination potential. This is a skilled yet tedious job that is time consuming and expensive; and fails to categorize seeds in more than two classes. Further, it poses a major production bottleneck when the ultimate desired output will be in the millions of plants.

Various methods have been proposed for using x-ray image analysis and machine learning models for seed classification based on germination potential. However, such approaches have limited efficiency because they rely on morphological descriptors of the seed (e.g., area and perimeter) as germination potential predictors, thus missing important information available in the image. Meanwhile, the approaches still require considerable manual interaction for labeling, segmentation, and/or processing of images.

Germination is a complex process, affected by numerous factors, some of them unknown or not visible in an image. Specifically, it is common to have seeds that have visual characteristics that predict good germination potential which do not germinate, and seeds that have visual characteristics that predict germination issues that still germinate. As such a machine learning model that is trained solely on visual characteristics of seeds cannot be accurate. It is also difficult to improve such models because the germination of seeds in the lab is costly and time consuming, and the association between the image and the categories such as germination/no germination is not straightforward. Finally, it is unlikely that such a model can be reused for predicting the germination potential of seeds of a crop that was not used for training of the model without complete retraining.

An aspect of some embodiments of the present invention relates to systems, methods, an apparatus, and/or code instructions for automated image segmentation and classification of seeds, optionally automated sorting of seeds according to the classification. The classification of seeds may refer to clustering of seeds having similar classification categories. X-ray images, each one including one or more seeds, are inputted into one or more neural networks. Optionally, images are segmented such that each image file includes a single seed. The neural network(s) compute an indication of the classification category(ies) (e.g., good, diseases, open hulled, empty, split/broken, etc.) for each seed depicted in the image(s), optionally at least according to weights and/or architecture of the trained neural network. The germination potential of the seeds is then determined as a function of the determined classification catergor(ies) (e.g., using a logistic regression model).

The above described solution has many advantages. For example, the present solution allows for generation of a model with minimal user intervention, for producing accurate and efficient estimates of germination potential of seeds. The present solution also allows for the model to be used for predicting the germination potential and vigor of a variety of seeds irrespective of the training dataset used.

The present solution is being described herein in the context of predicting germination of rice seeds. The present solution is not limited to rice seed germination prediction applications. The present solution can be used for other seed types such as, without limitation, wheat, maize, millets, cereal crops, or the like.

### Illustrative Systems

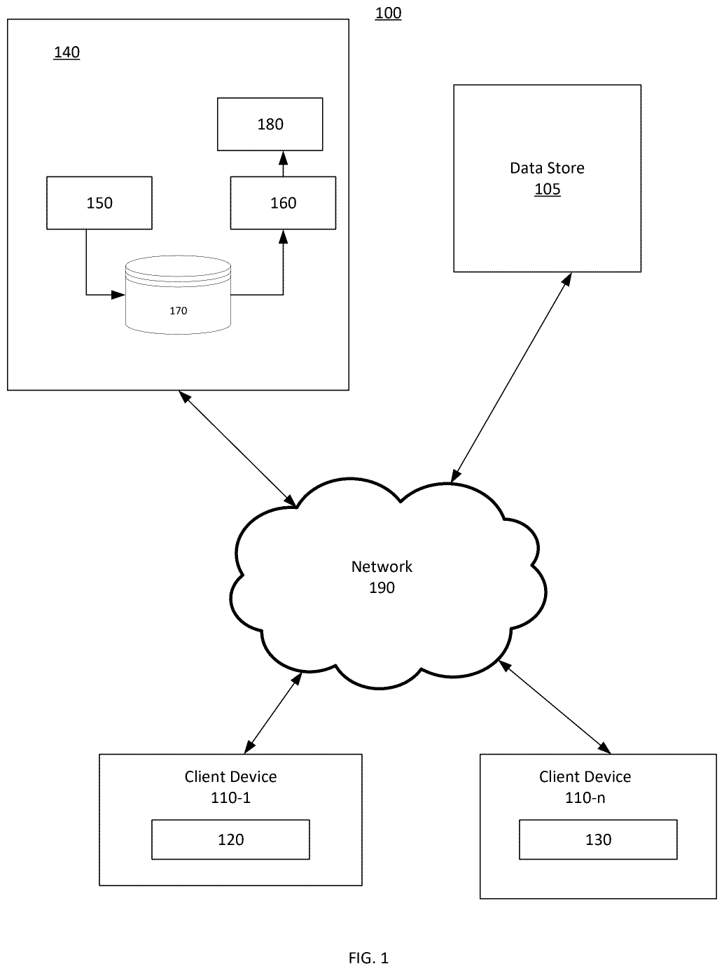

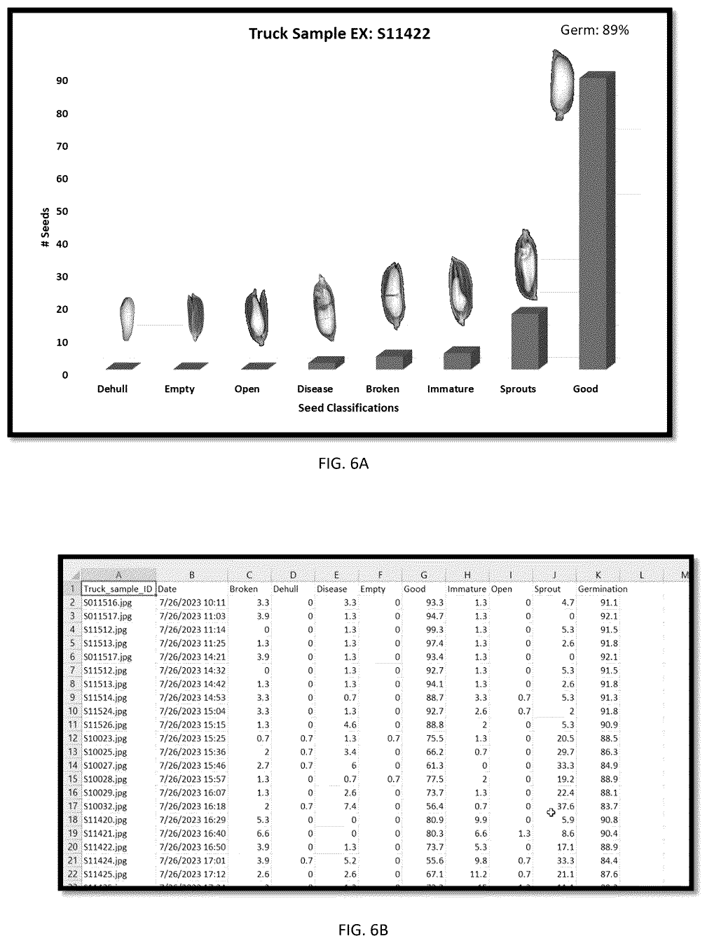

FIG. 1 depicts an example environment 100 in which selected aspects of the present disclosure may be implemented. Any computing devices depicted in FIG. 1 or elsewhere in the figures may include logic such as one or more microprocessors (e.g., central processing units or “CPUs”, graphical processing units or “GPUs”) that execute computer-readable instructions stored in memory, or other types of logic such as application-specific integrated circuits (“ASIC”), field-programmable gate arrays (“FPGA”), and so forth; and are discussed in more detail below with respect to FIG. 6.

In various implementations, the environment 100 may include a plurality of client devices 110-1, . . . , 110-n, a seed gemination prediction system 140, and data sources 105. Each of the plurality of client devices 110-1, . . . , 110-n, the seed germination prediction system 140, and the data sources 105 may be implemented in one or more computers that communicate, for example, through a computer network 190. The seed germination prediction system 140 is an example of an information retrieval system in which the systems, components, and techniques described herein may be implemented and/or with which systems, components, and techniques described herein may interface. Some of the systems depicted in FIG. 1, such as the seed germination prediction system 140 and the data sources 105, may be implemented using one or more server computing devices that form what is sometimes referred to as a “cloud infrastructure,” although this is not required.

An individual (who in the current context may also be referred to as a “user”) may operate one or more of the client devices 110-1, . . . , 110-n to interact with other components depicted in FIG. 1. Each component depicted in FIG. 1 may be coupled with other components through one or more networks, such as the computer network 190, which may be a local area network (LAN) or wide area network (WAN) such as the Internet. Each of the client devices 110-1, . . . , 110-n may be, for example, a desktop computing device, a laptop computing device, a tablet computing device, a mobile phone computing device, a computing device of a vehicle of the user, a standalone interactive speaker (with or without a display), or a wearable apparatus of the participant that includes a computing device (e.g., a watch of the participant having a computing device, glasses of the participant having a computing device). Additional and/or alternative client devices may be provided.

Each of the client devices 110-1, . . . , 110-n and the seed germination prediction system 140 may include one or more memories for storage of data and software applications, one or more processors for accessing data and executing applications, and other components that facilitate communication over a network. The operations performed by the client devices 110-1, . . . , 110-n and the seed germination prediction system 140 may be distributed across multiple computer systems. The seed germination prediction system 140 may be implemented as, for example, computer programs running on one or more computers in one or more locations that are coupled to each other through a network.

Each of the client devices 110-1, . . . , 110-n may operate a variety of different applications. For example, a first client device 110-1 may operate a training client 120 (e.g., which may be standalone or part of another application, such as part of a web browser), that may allow a user to initiate training, by training module 150 of the seed germination prediction system 140, of the one or more machine learning models (e.g., instance segmentation models, deep learning models, etc. discussed below) in the machine learning model database 170 of the seed germination prediction system 140 to generate output that is indicative of, for instance, predicted seed properties. Another client device 110-n may operate a seed germination prediction client 130 that allows a user to initiate and/or study seed property predictions provided by the inference module 160 of the seed germination prediction system 140, using one or more of machine learning models in the machine learning model database 170 and/or seed germination predictions provided by the germination predictor module 180 of the seed germination prediction system 140.

The seed germination prediction system 140 may be configured to practice selected aspects of the present disclosure to provide users, e.g., a user interacting with the seed germination prediction client 130, with data related to seed germination predictions. In various implementations, the seed germination prediction system 140 may include a training module 150, an inference module 160, a model database 170, and a germination predictor module 180. In other implementations, one or more of the training module 150, the inference module 160, the model database 170, and the germination predictor module 180 may be combined and/or omitted. The training module 150 may be configured to train one or

more machine learning models to generate data or output indicative of one or more qualities or properties of the seeds. These machine learning models may be applicable in various ways under various circumstances.

In various embodiments, a first machine learning model may be an instance segmentation model trained to identify individual instances of seeds in an image including a plurality of seeds. In various other embodiments, a second machine learning model may be model trained to generate seed characteristics data for each of the individual instances of seeds in an image. The seed characteristics may then be used to determine the germination potential of the seeds.

For example, one machine learning model may be trained to generate instance segmentation and/or seed characteristics data for rice seeds. Another machine learning model may be trained to generate instance segmentation and/or seed characteristics data for another seed type. Additionally or alternatively, in some implementations, a single machine learning model may be trained to generate instance segmentation and/or seed characteristics data for multiple types of seeds. In some such implementations, the type of seed under consideration may be applied as input across the machine learning model, along with other data described herein. Similarly, the germination prediction function may be generated for rice seeds, other seed types, or multiple seed types.

The machine learning models trained by the training module 150 may take various forms. In some implementations, one or more machine learning models trained by the training module 150 may come in the form of neural networks. These may include, for instance, convolutional neural networks. In other implementations, the machine learning models trained by the training module 150 may include other types of neural networks and any other type of artificial intelligence model. In various implementations, the training module 150 may store the machine learning models it trains in a machine learning model database 170.

In some implementations, the training module 150 may be configured to receive, obtain, and/or retrieve training data in the form of observational data and/or images described herein and apply it across a neural network (e.g., a convolutional neural network) to generate output. The training module 150 may compare the output to a ground truth (e.g., seed properties/labeled images, etc.), and train the neural network based on a difference or “error” between the output and the ground truth. In some implementations, this may include employing techniques such as gradient descent and/or back propagation to adjust various parameters and/or weights of the neural network. Other types of machine learning models such as deep learning models (e.g., autoencoders, multilayer perceptrons, etc.) are within the scope of this disclosure. In some embodiments, the machine learning model is trained to perform instance segmentation of x-ray image of rice seeds that is trained and validated using a large dataset of seed images (e.g., X-ray images). In some embodiments, the machine learning model is a deep learning model trained to perform multiclass and multilabel classification of X-ray image of rice seeds that is trained and validated using a large dataset of seed images (e.g., X-ray images).

The inference module 160 may be configured to apply input data across trained machine learning models contained in the machine learning model database 170. These may include machine learning models trained by the training module 150 and/or machine learning models trained elsewhere and uploaded to the machine learning model database 170. Similar to the training module 150, in some implementations, the inference module 160 may be configured to receive, obtain, and/or retrieve observational data and/or images apply it across a neural network to generate output including predicted seed properties. Assuming the neural network is trained, then the output may be indicative of various characteristics of the seeds, which may then be used by the inference module 160 to predict a seed germination by the germination predictor module 180.

The training module 150 and/or the inference module 160 may receive, obtain, and/or retrieve input data from various sources, such as the data sources 105. This data received, obtained, and/or retrieved from the data sources 105 may include observational data and/or images (e.g., X-ray images of seeds). The observational data may include data that is obtained from various sources, including but not limited to sensors (weight, moisture, temperature, ph levels, soil composition), users, and so forth. In implementations, a source of images may be a plurality of digital images of a plurality of pod-bearing plants obtained, e.g., using a multi-camera array installed on a combine, tractor, or other farm machinery. The plurality of digital images may include x-ray images of the seeds obtained from an x-ray camera. For example, the x-ray camera may be an x-ray imaging system (e.g., a Faxitron® Path Specimen Radiography System) configured to image the seeds at a plurality of positions as the seeds move through a system (e.g., over a conveyor belt). The digital images may have sufficient spatial resolution such that, when they are applied as input across one or more of the machine learning models in the machine learning model database 170, the models generate output that is likely to accurately predict one or more properties or characteristics of the seeds, which may then be used by the seed predictor module to accurately predict seed germination.

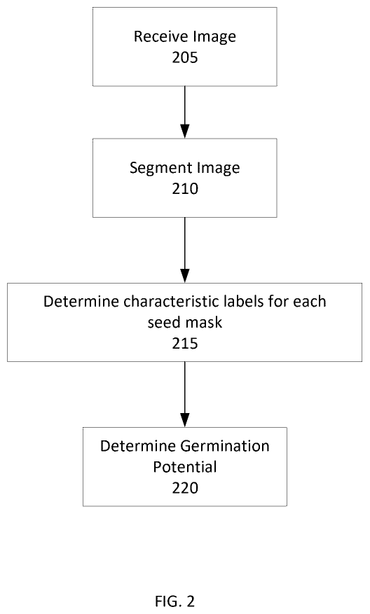

FIG. 2 is a flowchart illustrating an example method 200 of predicting germination potential of seeds, in accordance with implementations disclosed herein. For convenience, the operations of the flowchart are described with reference to a system that performs the operations. This system may include various components of various computer systems, such as one or more components of the client devices 110-1, . . . , 110-n, the seed germination prediction system 140, and/or the data sources 105. Moreover, while operations of method 200 are shown in a particular order, this is not meant to be limiting. One or more operations may be reordered, omitted, or added.

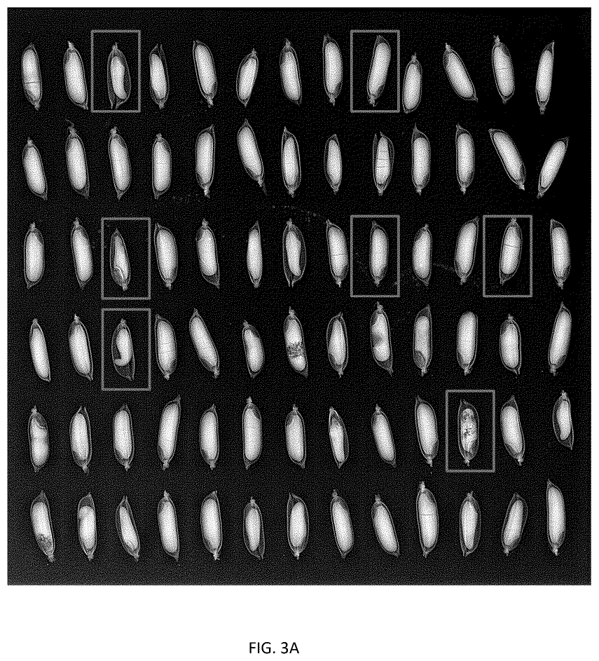

At block 205, the system may obtain a digital image of at least one seed (or an image comprising a plurality of images of a plurality of seeds). In implementations, at block 205, the germination predictor module 180 of the seed germination prediction system 140 may receive a request to predict seed germination potential from the seed germination prediction client 130 of the client device 110-n. In response to receiving the request, the germination predictor module 180 may obtain at least one digital image, from the data sources 105 (and/or imaging devices such as X-ray machines). In implementations, the digital image may be a RGB (red/green/blue) image. In other implementations, the digital image may be an x-ray images or other hyperspectral images. An example image 300 is shown in FIG. 3A and includes a plurality of seed images 310a-n.

Still referring to FIG. 2, at block 210, the system may segment the digital image to identify and separate individual seeds within the first digital image. In implementations, at block 210, the inference module 160 of the seed germination prediction system 140 may segment the digital image to identify at least one individual instance of a seed (instance segmentation). The inference module 160 can use a trained machine learning model to perform instance segmentation. In implementations, at block 210, the inference module 160 of the seed germination prediction system 140 applies, as inputs across one or more of the machine learning models trained as described with respect to FIG. 1 and stored in the machine learning model database 170, the X-ray image received at block 205 to generate output including a plurality of seed mask files. In implementations, the inference module 160 can use instance segmentation techniques to identify the pixel boundaries of each of the seeds in the digital image, as discussed below.

In various embodiments, the methods may include using a Segment Anything Model (SAM) (Segment Anything, Kirillov et al. 2023) for performing instance segmentation. Specifically, the SAM segmentation model includes an image encoder for computing an image embedding, a prompt encoder that embeds prompts, and a lightweight mask decoder that predicts segmentation masks. Compared with other traditional segmentation networks, the SAM model can obtain more types of objects, so that more information on an image can be utilized to realize higher calibration precision.

Often when an SAM model is used to perform instance segmentation over an entire image, not all the seeds may be assigned a mask. This issue may be addressed by splitting the received digital image in four similar slices, and then using SAM over each of the slices to improve accuracy of instance segmentation. In addition, SAM may generate numerous similar masks associated with the same seeds, including masks which are not seeds (like regular boxes bounding the seeds).

Specifically, the acquired digital image is sliced into a plurality of sliced images (each sliced image being a subset of the digital image), and SAM is used to perform instance segmentation on each of the sliced images. In certain embodiments, these is no overlap between the plurality of sliced images. When performed on a subset of the image, SAM is often more accurate.

In some examples, the image is sliced using, for example, row and column indices derived for the digital image (using any now or hereafter known methods). Optionally, the row and column indices may be derived by: (1) generating two or more segmentation mask images (e.g., 2, 3, 4) for the digital image, and (2) identifying row and column indices corresponding to object instances that are coincident (or have at least a threshold overlap) in the background of each of the generated mask images. The segmentation mask images (or “masks”) may include one or more masks associated with the seeds and/or other objects within the image. Of the indices received in step (2), those closer to the center of the image may be selected (such that the slices are not too large). In various embodiments, at least two of the masks may be generated using different machine learning models such as, without limitation, SAM, Scikit-image, Unet, FastFCN, or the like. Scikit-image, as used herein, refers to an open-source image processing library for the Python programming language. The scikit-image library includes algorithms for segmentation, mask generation, geometric transformations, color space manipulation, analysis, filtering, morphology, and feature detection. Specifically, for example, a first mask is generated using SAM and a second mask is generated using Scikit-image. The identified row and column indices are used to slice the image into a plurality of slices (e.g., 3, 4, 5, 6, etc.). In some embodiments, the image is sliced into four slices. Other now or hereafter known methods for slicing the image are within the scope of this disclosure.

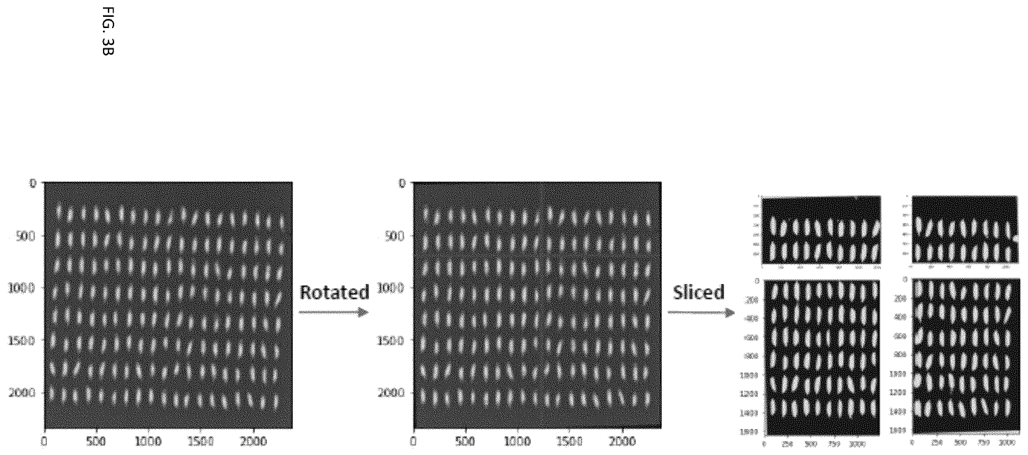

In cases where no row and column indices of pure background are immediately found, the image may be processed by rotating the image at a plurality of rotation angles until identification of a rotation angle that yields an appropriate set of row and column indices for slicing the image. FIG. 4 shows an example of a digital image that is rotated for identification of the row and the column that are subsequently used to slice the image, and the corresponding slices of the rotated images.

Other image processing steps before or after slicing are within the scope of this disclosure and may include, for example, removal of noise, processing using image filters, color correction, or the like.

As discussed above, SAM is used to perform instance segmentation on each of the sliced images to generate instance segmentation masks for seed instances within each of the sliced images.

Each instance segmentation mask may, optionally, be filtered based on seed morphology to check whether the mask parameters are within the range of parameters associated with seeds. For example, Scikit-image library algorithm “skimage.morphology” may be used to analyze the mask parameters to estimate attributes such as area, perimeter, lengths of the main and secondary axes, inertia tensor, or other shape related parameters. Additionally and/or alternatively, secondary attributes such as a ratio between the length of the main and the secondary axes, a ratio between the diagonal and the off-diagonal element of the inertia tensor, etc. may be derived. The estimated attribute value is analyzed to determine whether it falls within a range including a minimum and maximum value for that attribute in order to determine whether the attribute corresponds to a seed. The range is obtained by computing the minimum and maximum values of the parameters for a plurality of masks known to be associated with the types of seeds being analyzed. If the mask is determined not to be a seed mask, the mask may be discarded. If the mask is determined to be a seed mask, it is stored in a data store (e.g., a data store including a database). Optionally, the seed mask may be associated with location coordinates (e.g., row and column coordinates, coordinates of a centroid, etc.) within the image.

Optionally, duplicate masks in the data store (i.e., mask associated with the same seed in the image) obtained from the plurality of image slices can be identified by pairwise analyzing the number of coincident pixels and/or the distance between their centroids. For example, masks having at least a threshold amount of overlap determined based on the number of coincident pixels and/or masks that have less than a threshold distance between their respective centroids may be determined to be duplicate masks of the same seed instance in the image. Optionally, upon identification of duplicate masks, the mask having the largest area is selected for storage and further analysis, while other masks are discarded.

In certain embodiments, the selected seed masks may be combined to form an image file (e.g., 400 shown in FIG. 4) comprising mask image files associated with a plurality of seeds (in a suitable format such as .png, jpeg, etc.) within the originally received digital image. The image file may, optionally, include the mask image files arranged based on the position of the corresponding seed instances in the image (e.g., row locations followed by column locations or vice versa), the position being determined based on the location coordinates of the seed mask centroids. Each mask image file can include a plurality of pixels (e.g., 204×114 pixels) corresponding to the seed mask and use 0 as background.

The above discussed image segmentation leverages the capabilities of image processing tools and models for delivering a seamless identification and separation of each of the seeds in the received digital image.

In other implementations, the inference module 160 can use other segmentation techniques such as semantic segmentation techniques to identify the pixel boundaries of the at least one seed in each of the digital image. For example, the inference module 160 can use a convolutional neural network to perform object detection or image segmentation to segment the digital image. In implementations, the inference module 160 can use object detection techniques to identify instances of seeds in the image. In other implementations, the inference module 160 can use instance segmentation techniques or other segmentation techniques such as semantic segmentation techniques to identify the pixel boundaries of each of the seeds.

Referring back to FIG. 2, at block 215, the system may analyze each of the seed masks (e.g., an image file include mask image file(s)) to determine one or more characteristics of the seeds. In implementations, at block 215, the inference module 160 of the seed germination prediction system 140 may determine the one or more characteristics of the seeds. The inference module 160 can use a trained machine learning model (e.g., a deep learning classifier) to determine the one or more characteristics of the seeds. In implementations, at block 215, the inference module 160 of the seed germination prediction system 140 applies, as inputs across one or more of the machine learning models trained as described with respect to FIG. 1 and stored in the machine learning model database 170, the seed masks received at block 210 to generate output including a plurality of labels indicative of seed characteristics for each seed mask.

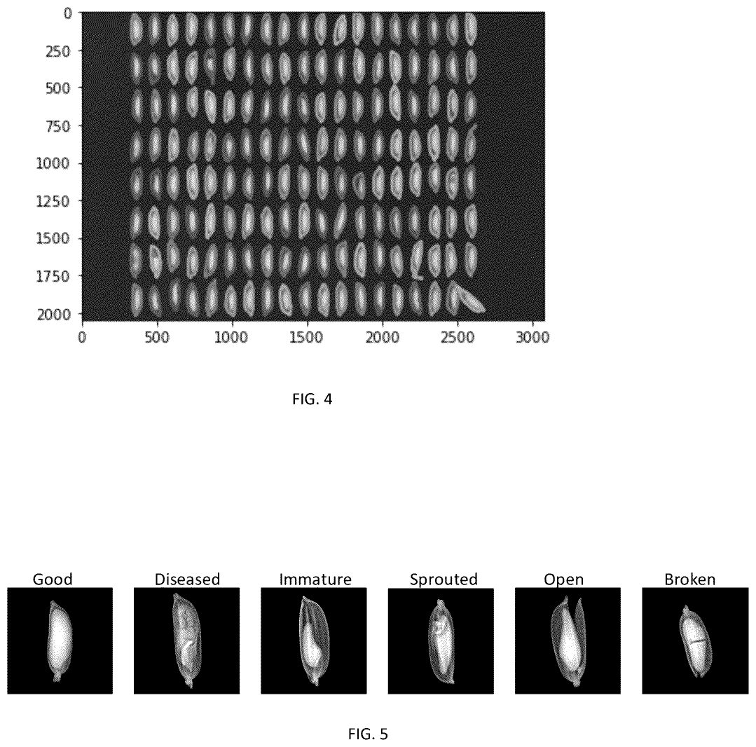

The characteristics may be selected to determine the germination potential of the seeds. In an implementation, the characteristics include, without limitation, good, diseased, sprouted, immature, broken or fissured, open-hulled, dehulled, and empty (shown in FIG. 5). Other characteristics may similarly be selected. The seed files may be assigned to more than one class. Because of the multilabel condition of the problem a class (i.e., a characteristic) is assigned to the image when the associated output coefficient is larger than a threshold value. Example threshold values may be about 0.25-0.4, about 0.27-0.38, about 0.29-0.36, about 0.3-0.35, about 0.29, about 0.3, about, 0.31, or the like.

The machine learning model may be trained and validated to perform multiclass and multilabel classification of mask images of seeds using a training dataset of seed images to classify and label the seeds masks based on the characteristics. For example, the training module 150 of the seed germination prediction system 140 may receive a request to train a model from a first client device 110-1 operating a training client 120. The training dataset may, for example, be received from data sources 105. The training dataset may include real data including labeled images of individual seeds and/or synthetic data (e.g., data generated using data augmentation for artificially growing the training set by generating modified copies of a dataset based on the existing data).

In some embodiments, training may include training an untrained model using training methods such as Keras and Tensorflow in Python. In other embodiments, training may include transfer learning where a pre-trained model is leveraged by removing certain layers and training on training datasets corresponding to seed image classification. Examples of pre-trained models include, without limitation, ResNet50V2, VGG16, Xception, InceptionResNetV2, EfficientNetV2L, etc.

In an example implementation, for training a pre-trained model, the pretrained layers were followed by dropout regularization and a batch-normalization. Additional layers may also be added. Optionally, this may be followed by another dropout regularization, batch-normalization, a flattening layer, and/or additional layer additions. The calibrated hyperparameters are suitably selected.

Still referring to FIG. 2, at block 220, the inferred characteristics of each of the seeds are used to determine a germination potential of that seed. In implementations, at block 220, the germination predictor module 180 of the seed germination prediction system 140 may determine the germination potential of the seeds based on the inferred characteristics. The germination predictor module 180 can use a trained logistic regression model to determine the germination potential as a function of the characteristics of the seeds. In the model the probability of germination, P(G) is a function of the Di class (i=1, 2 . . . 8):

$$P ( G ) = \frac{exp ( {a}_{0} + {a}_{1} \times {D}_{1} + … {a}_{i} \times {D}_{i} + … {a}_{N} \times {D}_{N} )}{1 + exp ( {a}_{0} + {a}_{1} \times {D}_{1} + … {a}_{i} \times {D}_{i} + … {a}_{N} \times {D}_{N} )} \\ with \\ {a}_{i} ( i = 0 , 1 , 2 … 8 )$$

being the coefficients of the model. Di class (i=1, 2 . . . 8) refer to the class labels good seed, immature seed, sprouted seed, diseased seed, open hulled seeds, dehulled, split/broken seed, and empty seed as determined in block 215.

Optionally, a plurality of the seed labels (i.e., inferred characteristics) and the corresponding germination prediction are stored as a dataset in a database. Further optionally, the seed masks and/or location within the image are also included in the dataset. The term “database” here means one or more computer data storages which are at least linked to each another. For example, in some cases, the database may at least partially be a cloud storage. Thus, the dataset may either be a single set or it may be split in smaller datasets at the same or different locations. In some cases, all or some of the seed labels and germination potentials may be stored collectively in the database. For example, in some cases, all of the seed labels or a subset thereof may be stored in the database and the associated germination potentials, or the subset thereof may be linked to the corresponding seeds locations within the image. An advantage of doing the above can be that the seed labels along with their respective germination potentials can be leveraged for selection of viable seeds for planting.

In some implementations, the seed classification labels (e.g., characteristics) and corresponding germination potentials are output. For example, a visual display may created to output the characteristics as various pixel colors (grey scale) and/or germination potential as a percentage. Alternatively and/or additionally, the ground segmentation may be output in a visual display as pixel colors applied to a range image.

In some embodiments, an output may be generated (e.g., a visual graphical output) for all the seeds in the received image sample. For example, FIG. 6A is a visual bar graph illustrating the number seeds in the image belonging to each class and the average germination potential of the seeds in the image. For example, FIG. 6B illustrates tabular output including the number of seeds assigned to each class and corresponding average germination potentials of seeds in a plurality of images.

In implementations, a single machine learning model, or an ensemble of machine learning models, may be used to perform the above aspects of example method 200.

In various implementations, systems and methods of the current disclosure describe segmentation of an x-ray image into different classes of seed and deliver seed classifications along with a predicted germination percentage. The classification and/or the predicted germination potential may be used for data-driven decision making at seed processing plants, research studies and inventory management (because several samples of larger sample sizes can be simultaneously analyzed) for better and instantaneous seed germ quality predictions. For example, seeds having a germination potential below a certain threshold may be discarded and not used for planting and/or a batch of seeds having a collective (or average) germination potential below a certain threshold may be discarded. Similarly, seeds having certain labels (e.g., diseased) may be separated from other seeds. Optionally, the determined germination potential may be used to predict crop yield associated with a batch of seeds. In some implementations, the germination potentials of seeds (and/or corresponding labels) may be provided to a seed sorting assembly and the seed sorting assembly may sort the seeds into separate bins based on germination potentials and/or labels.

The methods disclosed herein provide high throughput prediction of seed germination potential (about 5 mins) compared to 10-15 days for determining the germination potential of seeds using existing methods in a lab. Given the high throughput and reduced number of required resources and manpower, the disclosed methods also allow for increasing the sample size for performing germination prediction tests on seed lots. Similarly, the methods can be efficiently used for analyzing the seed for diseases and other seed classifications which affect seed quality.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Hence, features from different embodiments disclosed herein may be freely combined. For example, one or more features from a method embodiment may be combined with any of the product embodiments. Similarly, features from a product embodiment may be combined with any of the method embodiments herein disclosed. Thus, the breadth and scope of the present solution should not be limited by any of the above-described embodiments. Rather, the scope of the present solution should be defined in accordance with the following claims and their equivalents.

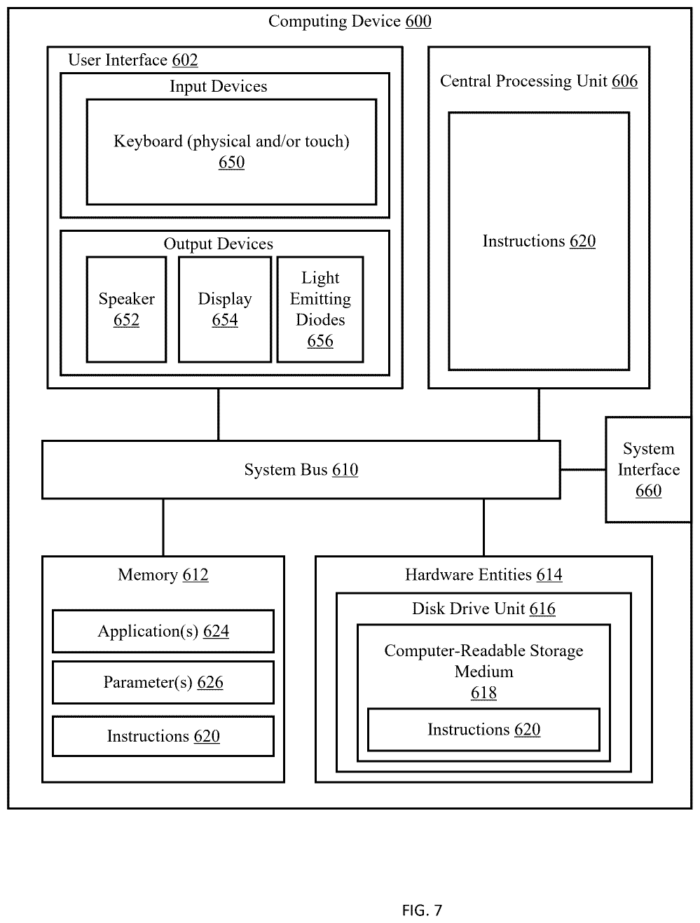

Referring now to FIG. 7, there is provided an illustration of an illustrative architecture for a computing device 700. The client devices 110 and/or the seed germination prediction system 140 of FIG. 1 is/are the same as or similar to computing device 700. As such, the discussion of computing device 700 is sufficient for understanding the client devices 110 and/or the seed germination prediction system 140 of FIG. 1.

Computing device 700 may include more or less components than those shown in FIG. 7. However, the components shown are sufficient to disclose an illustrative solution implementing the present solution. The hardware architecture of FIG. 7 represents one implementation of a representative computing device, as described herein. As such, the computing device 700 of FIG. 7 implements at least a portion of the method(s) described herein.

Some or all components of the computing device 700 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 7, the computing device 700 comprises a user interface 702, a Central Processing Unit (CPU) 706, a system bus 710, a memory 712 connected to and accessible by other portions of computing device 700 through system bus 710, a system interface 760, and hardware entities 714 connected to system bus 710. The user interface can include input devices and output devices, which facilitate user-software interactions for controlling operations of the computing device 700. The input devices include, but are not limited to, a physical and/or touch keyboard 750. The input devices can be connected to the computing device 700 via a wired or wireless connection (e.g., a Bluetooth® connection). The output devices include, but are not limited to, a speaker 752, a display 754, and/or light emitting diodes 756. System interface 760 is configured to facilitate wired or wireless communications to and from external devices (e.g., network nodes such as access points, etc.).

At least some of the hardware entities 714 perform actions involving access to and use of memory 712, which can be a Random Access Memory (RAM), a disk drive, flash memory, a Compact Disc Read Only Memory (CD-ROM) and/or another hardware device that is capable of storing instructions and data. Hardware entities 714 can include a disk drive unit 716 comprising a computer-readable storage medium 718 on which is stored one or more sets of instructions 720 (e.g., software code) configured to implement one or more of the methodologies, procedures, or functions described herein. The instructions 720 can also reside, completely or at least partially, within the memory 712 and/or within the CPU 706 during execution thereof by the computing device 700. The memory 712 and the CPU 706 also can constitute machine-readable media. The term “machine-readable media”, as used here, refers to a single medium or multiple media (e.g., a centralized or distributed database, and/or associated caches and servers) that store the one or more sets of instructions 720. The term “machine-readable media”, as used here, also refers to any medium that is capable of storing, encoding or carrying a set of instructions 720 for execution by the computing device 700 and that cause the computing device 700 to perform any one or more of the methodologies of the present disclosure.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A method for predicting the germination potential of seeds, the method comprising, by a processor:
receiving an image comprising a plurality of seeds;
segmenting the image to identify instance masks associated with the plurality of seeds; and
for each of the plurality of instance masks:
determining one or more of a plurality of characteristic labels, and
determining based on the one or more of the plurality of characteristic labels, a germination potential of a seed associated with that instance mask.

2. The method according to claim 1, wherein the image is an x-ray image.

3. The method according to claim 1, wherein segmenting the image to identify instance masks associated with the plurality of seeds comprises slicing the image into a plurality of slices, and segmenting each of the plurality of slices using a Segment Anything Model (SAM).

4. The method according to claim 3, wherein slicing the image into a plurality of slices comprises:
determining a first mask of the image using SAM;
determining a second mask of the image using Scikit-image;
identifying, based on the first mask and the second mask, row and column indices associated with each of the plurality of seeds in the image; and
slicing the image using the row and column indices.

5. The method of claim 3, further comprising identifying and discarding instance masks that have one or more attribute values that do not correspond to seed masks.

6. The method according to claim 5, wherein the one or more attribute values comprise at least one of the following: area, perimeter, length of main axis, length of secondary axis, inertia tensor, a ratio between the length of the main axis and length of the secondary axis, or a ratio between a diagonal and an off-diagonal element of the inertia tensor.

7. The method according to claim 3, further comprising identifying and discarding duplicate seed instance masks.

8. The method according to claim 1, wherein the plurality of characteristic labels comprise at least one of the following: broken, dehulled, diseased, empty, good, immature, open, or sprouted.

9. The method according to claim 1, wherein determining, based on the one or more of the plurality of characteristic labels, the germination potential of the seed associated with that instance mask comprises determining the germination potential using a logical regression model.

10. The method according to claim 9, wherein the logical regression model comprises:
$$P ( G ) = \frac{exp ( {a}_{0} + {a}_{1} \times {D}_{1} + … {a}_{i} \times {D}_{i} + … {a}_{N} \times {D}_{N} )}{1 + exp ( {a}_{0} + {a}_{1} \times {D}_{1} + … {a}_{i} \times {D}_{i} + … {a}_{N} \times {D}_{N} )} \\ with \\ {a}_{i} ( i = 0 , 1 , 2 … 8 )$$
being coefficients of the model, and Di being a characteristic label.

11. The method according to claim 1, wherein determining one or more of the plurality of characteristic labels comprises using a deep learning algorithm.

12. The method according to claim 1, further comprising generating an output comprising a graphical display indicative of, for the image: a number of seeds associated with each of the plurality of characteristic labels and an average germination potential.

13. A system, comprising:
a processor; and
a non-transitory computer-readable storage medium comprising programming instructions that are configured to cause the processor to implement a method for predicting germination potential of seeds, wherein the programming instructions comprise instructions to cause the processor to:
receive an image comprising a plurality of seeds,
segment the image to identify instance masks associated with the plurality of seeds, and
for each of the plurality of instance masks:
determine one or more of a plurality of characteristic labels, and
determine based on the one or more of the plurality of characteristic labels,
a germination potential of a seed associated with that instance mask.

14. The system according to claim 13, wherein the instructions that cause the processor to segment the image to identify instance masks associated with the plurality of seeds comprise instructions to slice the image into a plurality of slices, and segmenting each of the plurality of slices using a Segment Anything Model (SAM).

15. The system according to claim 14, wherein the instructions that cause the processor to slice the image into a plurality of slices comprise instructions to:
determine a first mask of the image using SAM;
determine a second mask of the image using Scikit-image;
identify, based on the first mask and the second mask, row and column indices associated with each of the plurality of seeds in the image; and
slice the image using the row and column indices.

16. The system of claim 14, further comprising instructions that cause the processor to discard instance masks that have one or more attribute values that do not correspond to seed masks.

17. The system according to claim 16, wherein the one or more attribute values comprise at least one of the following: area, perimeter, length of main axis, length of secondary axis, inertia tensor, a ratio between the length of the main axis and length of the secondary axis, or a ratio between a diagonal and an off-diagonal element of the inertia tensor.

18. The system according to claim 14, further comprising instructions that cause the processor to identify and discard duplicate seed instance masks.

19. The system according to claim 13, wherein the plurality of characteristic labels comprise at least one of the following: broken, dehulled, diseased, empty, good, immature, open, or sprouted.

20. The system according to claim 13, wherein instructions that cause the processor to determine based on the one or more of the plurality of characteristic labels, the germination potential of the seed associated with that instance mask comprise instructions that cause the processor to determine the germination potential using a logical regression model.

21. The system according to claim 9, wherein the logical regression model comprises:
$$P ( G ) = \frac{exp ( {a}_{0} + {a}_{1} \times {D}_{1} + … {a}_{i} \times {D}_{i} + … {a}_{N} \times {D}_{N} )}{1 + exp ( {a}_{0} + {a}_{1} \times {D}_{1} + … {a}_{i} \times {D}_{i} + … {a}_{N} \times {D}_{N} )} \\ with \\ {a}_{i} ( i = 0 , 1 , 2 … 8 )$$
being coefficients of the model, and Di being a characteristic label.

22. The system according to claim 1, further comprising instructions that cause the processor to generate an output comprising a graphical display indicative of, for the image: a number of seeds associated with each of the plurality of characteristic labels and an average germination potential.
